(19) United States
(12) Patent Application Publication
(10) Pub. No.: US 2016/0271761 A1
(43) Pub. Date: Sep. 22, 2016

(54) Silent socket wrench

(71) Applicant: Ting-Kai Chang, Taichung City (TW)

(72) Inventor: Ting-Kai CHANG, Taichung City (TW)

(21) Appl. No.: 14/658,254

(22) Filed: Mar. 16, 2015

(51) Int. Cl. B25B 13/46

(52) U.S. Cl. CPC B25B 13/462

(57) ABSTRACT

A silent socket wrench contains: a body, a driving, a cavity, a peripheral rib, and a C-shaped groove. A ratchet member is fixed on the peripheral rib and includes a plurality of teeth, a square recess, four retaining notches, and a through orifice for inserting a limiting element. When the ratchet member is accommodated in the cavity, among a vertical rim of each tooth, a tilted rim of each tooth, and the inner wall of the cavity is defined an operating space for mounting an elastic piece and a rolling shaft, and the elastic piece is retained between the vertical rim and the rolling shaft. A stop ring and a C retainer are fixed on the ratchet member in the cavity, and the C retainer is retained in the C-shaped groove. A connector is inserted into the square recess and includes two locking balls and a slot.

### FIELD OF THE INVENTION

The present invention relates to a silent socket wrench in which a connector controls a body to rotate clockwise and counterclockwise easily.

### BACKGROUND OF THE INVENTION

A conventional ratchet tool contains a ratchet portion, a driving block, and a resilient element for limiting or releasing the ratchet portion, wherein a control button is pressed to change an operating direction.

In addition, a plurality of teeth are arranged around the ratchet portion to engage with or to disengage from a driving head of the ratchet tool. However, the plurality of teeth friction with the driving head to make noises easily. Furthermore, the resilient element causes elasticity fatigue after a long period of using time.

The present invention has arisen to mitigate and/or obviate the afore-described disadvantages.

### SUMMARY OF THE INVENTION

The primary objective of the present invention is to provide a silent socket wrench in which a connector controls a body to rotate clockwise and counterclockwise easily.

To obtain the above objective, a silent socket wrench provided by the present invention contains: a body, a driving head formed on a front end of the body, a cavity defined in the driving head, a peripheral rib extending inwardly from a bottom end of an inner wall of the cavity, and a C-shaped groove formed around a top end of the inner wall of the cavity.

A ratchet member is fixed on the peripheral rib of the cavity, the ratchet member includes a plurality of teeth arranged around an outer wall of the ratchet member, a square recess defined on a central position thereof, four retaining notches formed around an inner wall thereof, and a through orifice defined in one of the plurality teeth to insert a limiting element.

Wherein when the ratchet member is accommodated in the cavity, among a vertical rim of each tooth, a tilted rim of each tooth, and the inner wall of the cavity is defined an operating space, wherein an elastic piece and a rolling shaft are mounted in the operating space, and the elastic piece is retained between the vertical rim and the rolling shaft.

A stop ring and a C retainer are fixed on the ratchet member in the cavity, wherein the C retainer is retained in the C-shaped groove of the cavity.

A connector is inserted into the square recess of the ratchet member, wherein the connector includes two locking balls engaged in an upper portion and a lower portion of one of four outer walls thereof and includes a slot defined on another of the four walls thereof and corresponding to the limiting element of the ratchet member.

### BRIEF DESCRIPTION OF THE DRAWINGS

FIG. 1 is a perspective view showing the assembly of a silent socket wrench according to a preferred embodiment of the present invention.

FIG. 2 is another perspective view showing the assembly of the silent socket wrench according to the preferred embodiment of the present invention.

FIG. 3 is a perspective view showing the exploded components of the silent socket wrench according to the preferred embodiment of the present invention.

FIG. 4 is a side plan view showing the operation of the silent socket wrench according to the preferred embodiment of the present invention.

FIG. 5 is another side plan view showing the operation of the silent socket wrench according to the preferred embodiment of the present invention.

FIG. 6 is also another side plan view showing the operation of the silent socket wrench according to the preferred embodiment of the present invention.

FIG. 7 is a cross sectional view showing the operation of the silent socket wrench according to the preferred embodiment of the present invention.

FIG. 8 is another cross sectional view showing the operation of the silent socket wrench according to the preferred embodiment of the present invention.

FIG. 9 is also another cross sectional view showing the operation of the silent socket wrench according to the preferred embodiment of the present invention.

FIG. 10 is still another cross sectional view showing the operation of the silent socket wrench according to the preferred embodiment of the present invention.

### DETAILED DESCRIPTION OF THE PREFERRED EMBODIMENTS

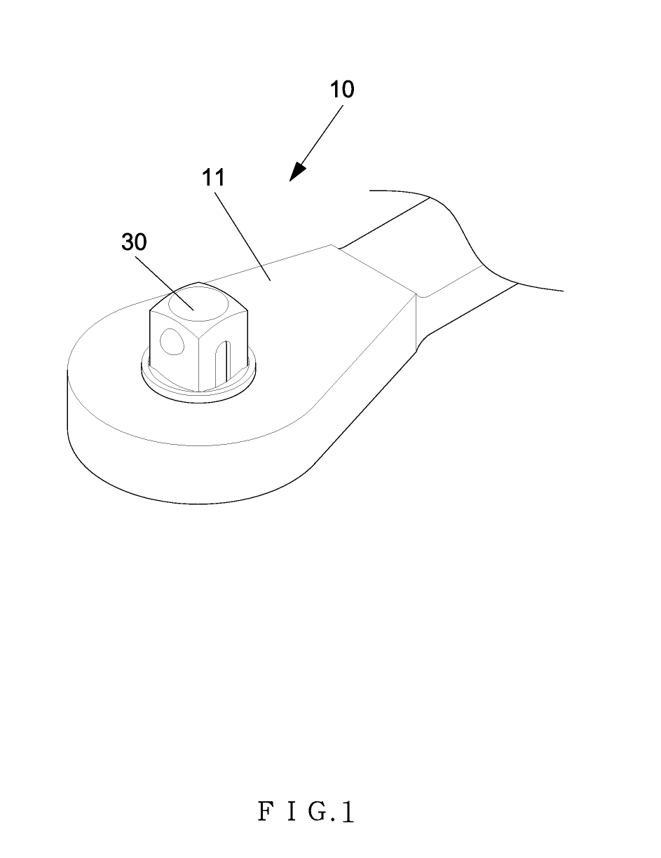

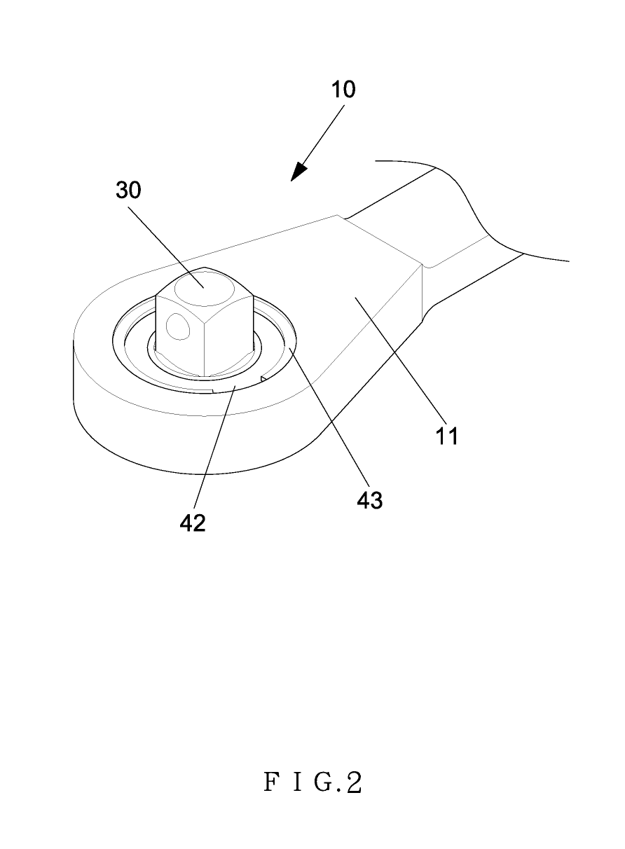

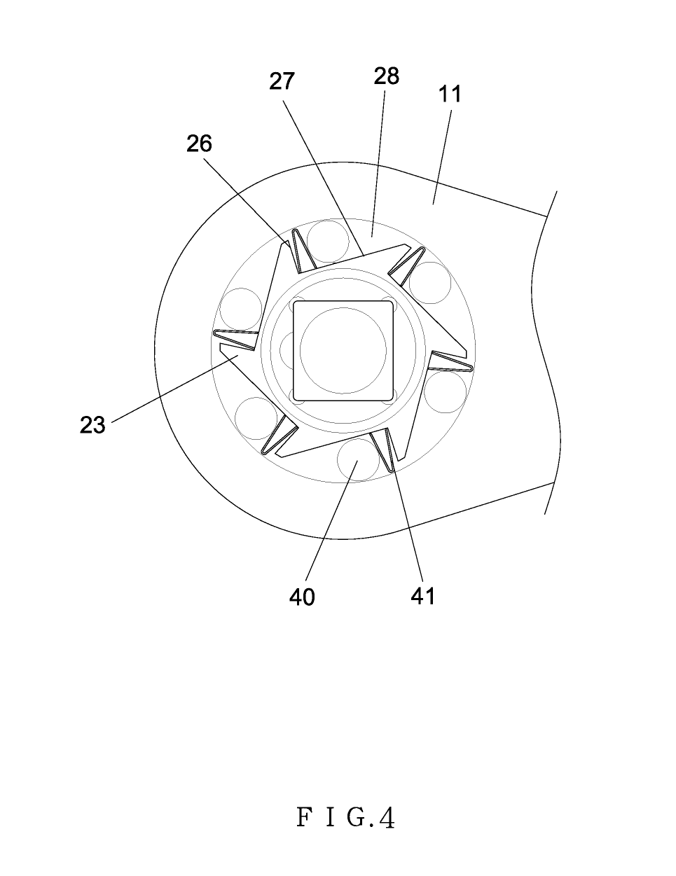

Referring to FIGS. 1 to 4, a silent socket wrench according to a preferred embodiment of the present invention comprises: a body 10, a driving head 11 formed on a front end of the body 10, a cavity 12 defined in the driving head 11, a peripheral rib 13 extending inwardly from a bottom end of an inner wall of the cavity 12, and a C-shaped groove 14 formed around a top end of the inner wall of the cavity 12, wherein a ratchet member 20 is fixed on the peripheral rib 13 of the cavity 12, the ratchet member 20 includes a plurality of teeth 23 arranged around an outer wall of the ratchet member 20, a square recess 21 defined on a central position thereof, four retaining notches 22 formed around an inner wall thereof, a through orifice 24 defined in one of the plurality teeth 23 to insert a limiting element 25, wherein when the ratchet member 20 is accommodated in the cavity 12, among a vertical rim 26 of each tooth 23, a tilted rim 27 of each tooth 23, and the inner wall of the cavity 12 is defined an operating space 28, wherein an elastic piece 41 and a rolling shaft 40 are mounted in the operating space 28, and the elastic piece 41 is retained between the vertical rim 26 and the rolling shaft 40; a stop ring 42 and a C retainer 43 are fixed on the ratchet member 20 in the cavity 12, wherein the C retainer 43 is retained in the C-shaped groove 14 of the cavity 12, hence the driving head 11 is connected with the ratchet member 20. Furthermore, a connector 30 is inserted into the square recess 21 of the ratchet member 20, wherein the connector 30 includes two locking balls 32 engaged in an upper portion and a lower portion of one of four outer walls thereof and includes a slot 31 defined on another of the four walls thereof and corresponding to the limiting element 25 of the ratchet member 20.

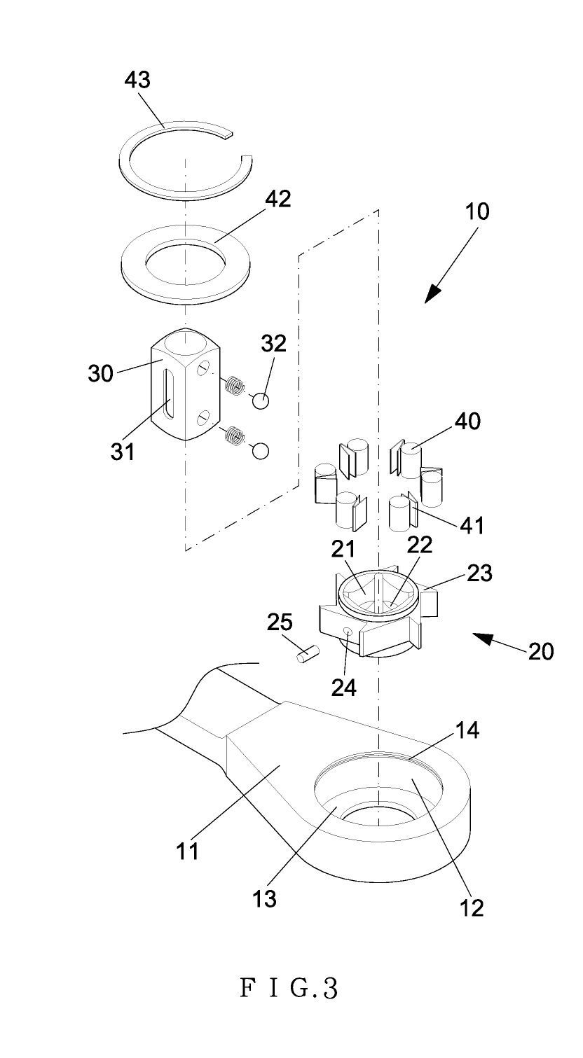

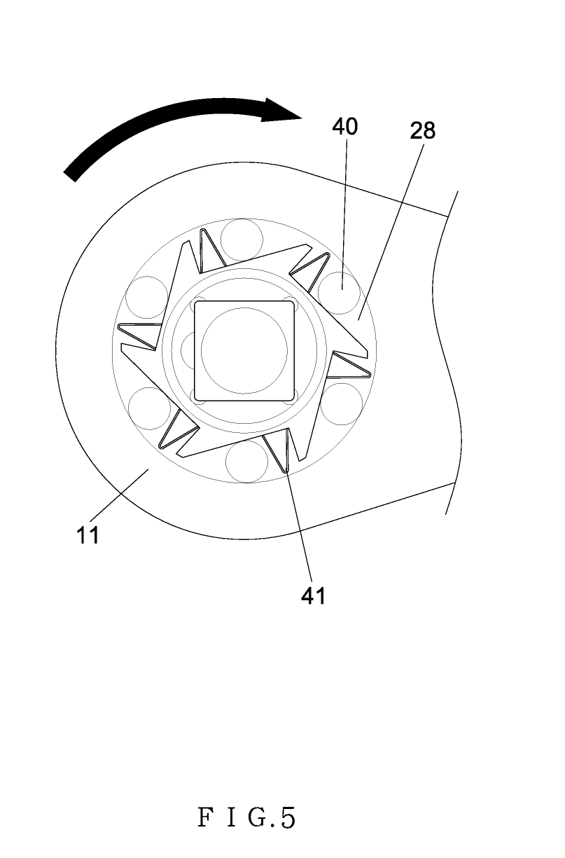

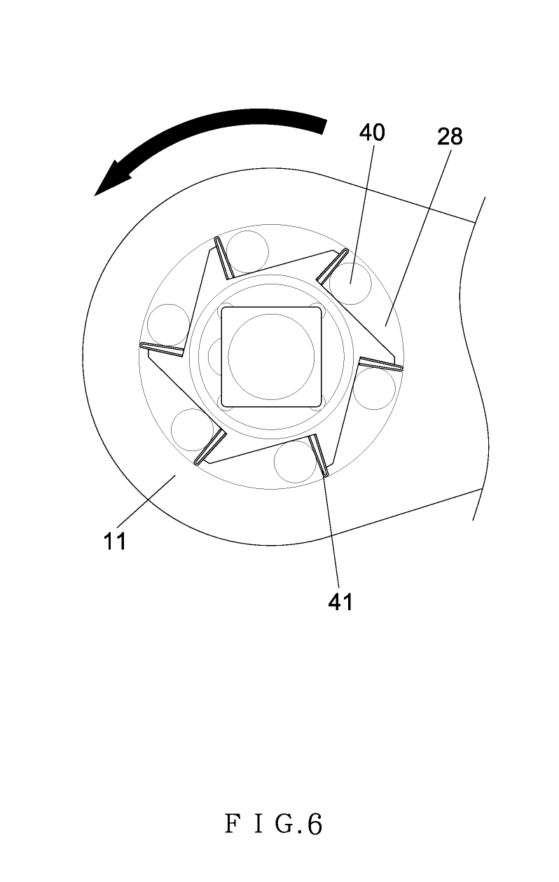

With reference to FIGS. 3 to 6, when the body 10 is rotated toward the tilted rim 27, the rolling shaft 40 moves toward a rear end of the tilted rim 27 and retains with the tilted rim 27 and the inner wall of the cavity 12, such that the ratchet member 20 is limited. When the body 10 is rotated toward the vertical rim 26, the rolling shaft 40 moves toward the elastic piece 41 to disengage from the tilted rim 27 and the inner wall of the cavity 12, hence the ratchet member 20 is rotated.

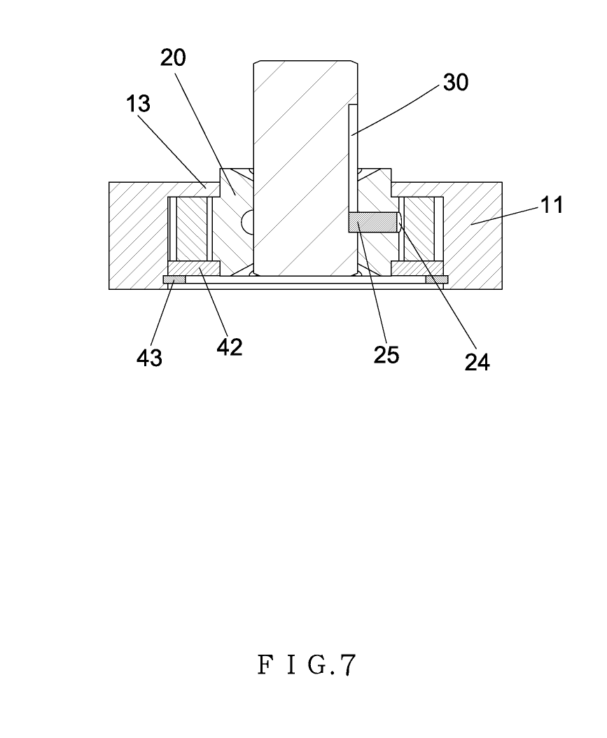

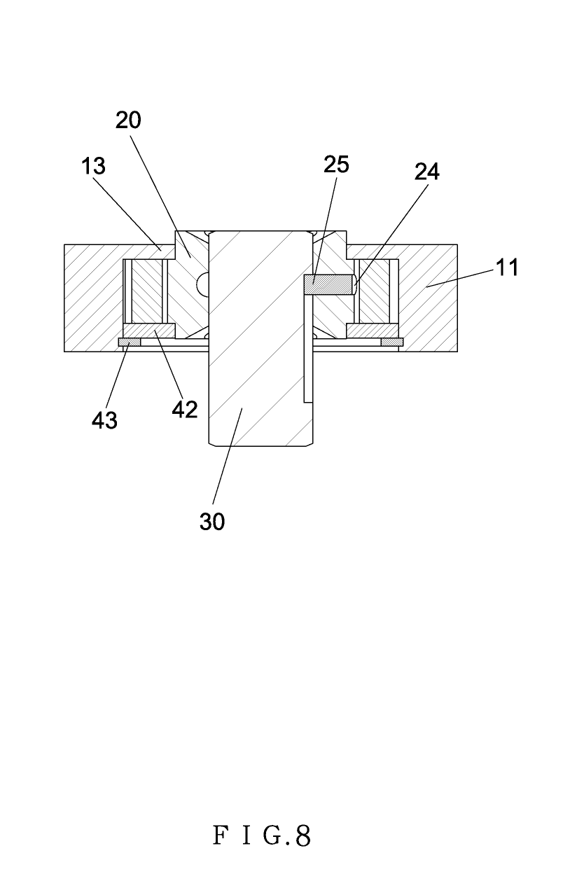

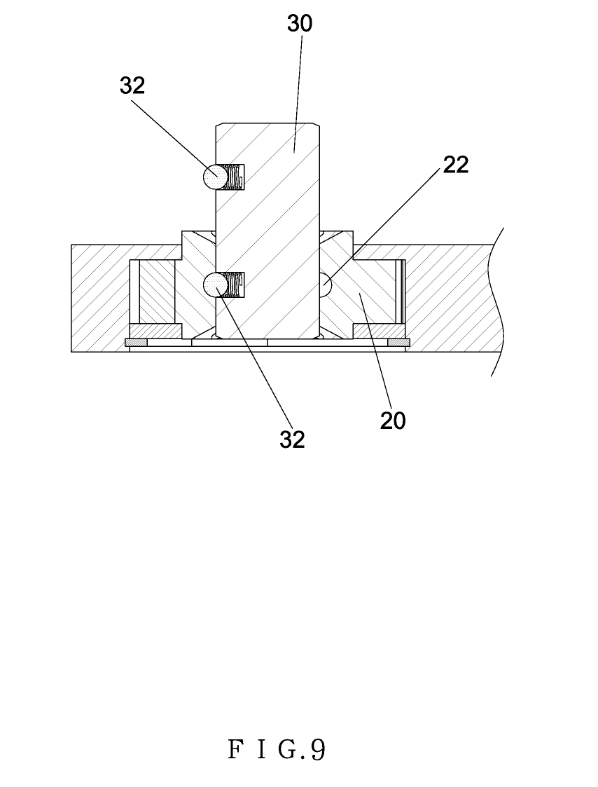

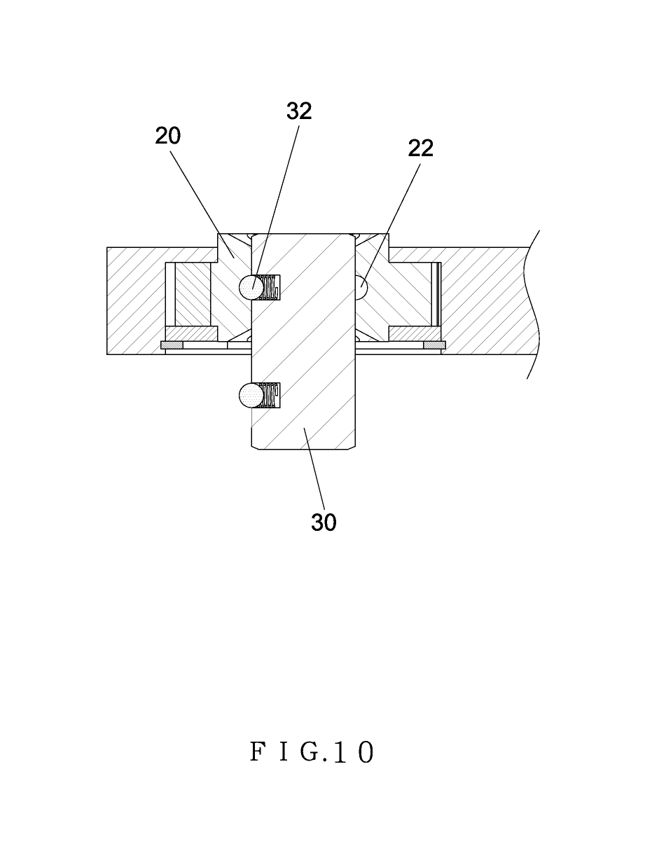

As shown in FIGS. 7 to 10, the limiting element 25 of the ratchet member 20 corresponds to and retains in the slot 31 of the connector 30 so that the connector 30 moves upwardly and downwardly, and the connector 30 retains in the four retaining notches 22 of the ratchet member 20 by ways of the two locking balls to control the connector 30 in the square recess 21 upwardly and the downwardly. Thereby, the connector 30 controls the body 10 to rotate clockwise and counterclockwise easily.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A silent socket wrench comprising:
a body, a driving head formed on a front end of the body, a cavity defined in the driving head, a peripheral rib extending inwardly from a bottom end of an inner wall of the cavity, and a C-shaped groove formed around a top end of the inner wall of the cavity;
a ratchet member fixed on the peripheral rib of the cavity, the ratchet member including a plurality of teeth arranged around an outer wall of the ratchet member, a square recess defined on a central position thereof, four retaining notches formed around an inner wall thereof, and a through orifice defined in one of the plurality teeth to insert a limiting element;
wherein when the ratchet member is accommodated in the cavity, among a vertical rim of each tooth, a tilted rim of each tooth, and the inner wall of the cavity is defined an operating space, wherein an elastic piece and a rolling shaft are mounted in the operating space, and the elastic piece is retained between the vertical rim and the rolling shaft;
wherein a stop ring and a C retainer are fixed on the ratchet member in the cavity, wherein the C retainer is retained in the C-shaped groove of the cavity;
wherein a connector is inserted into the square recess of the ratchet member, wherein the connector includes two locking balls engaged in an upper portion and a lower portion of one of four outer walls thereof and includes a slot defined on another of the four walls thereof and corresponding to the limiting element of the ratchet member.

2. The silent socket wrench as claimed in claim 1, wherein the limiting element of the ratchet member corresponds to and retains in the slot of the connector so that the connector moves upwardly and downwardly.

3. The silent socket wrench as claimed in claim 1, wherein the connector retains in the four retaining notches of the ratchet member by ways of the two locking balls to control the connector move in the square recess upwardly and the downwardly.
